(19) United States
(12) Patent Application Publication
(10) Pub. No.: US 2009/0114418 A1
(43) Pub. Date: May 7, 2009

(54) WIRE WITH CONVERTIBLE OUTER JACKET AND METHOD THEREOF

(75) Inventors: Manville D. SMITH, Coconut Creek, FL (US); Dean ELLIS, Ellijay, GA (US)

Correspondence Address: CHRISTOPHER & WEISBERG, P.A., 200 EAST LAS OLAS BOULEVARD, SUITE 2040, FORT LAUDERDALE, FL, 33301, US

(73) Assignee: JL AUDIO, INC., Miramar, FL (US)

(21) Appl. No.: 11/936,274

(22) Filed: Nov. 7, 2007

(51) Int. Cl. H01B 7/36; B05D 5/12

(52) U.S. Cl. 174/112; 427/118

(57) ABSTRACT

A multi-jacket electrical cable that includes an inner insulation jacket wrapped around or extruded onto one or more electrical conductors and an outer insulation jacket that is wrapped around or extruded onto the inner jacket and is removable therefrom. Each jacket includes a different characteristic such as color, texture of pattern. A user of the electrical cable of the present invention can designate the wire to be used for a particular purpose, such as a ground wire, or a high voltage wire, by removing a jacket until an inner jacket is exposed, where the exposed jacket has a characteristic that matches the user's desired intention for the wire.

### CROSS-REFERENCE TO RELATED APPLICATION

n/a

### STATEMENT REGARDING FEDERALLY SPONSORED RESEARCH OR DEVELOPMENT

n/a

### FIELD OF THE INVENTION

The present invention generally relates to electrical wires and cables, and in particular, to an indicia-coded electrical cable having an easily removable outer jacket of a first characteristic indicia and an inner jacket of a second characteristic indicia.

### BACKGROUND OF THE INVENTION

Identifying types of electrical wires by color-coding or indicia-coding the outer cable jacket is common in the art. It is common practice for DC and/or AC power wiring to utilize wires with different color jackets to indicate positive or negative. Electrical cables are often color-coded for safety reasons and to help properly identify the conductive wires contained therein. This reduces confusion and prevents accidental misconnection or accidents during use. For example, the color white typically identifies a “neutral” wire, black and red wires are generally considered to be “hot” wires, while green or un-insulated wires are generally known as “grounding” wires. Further identifying indicia may be needed when it is desirable to identify high voltage (typically brown, orange and yellow) and low voltage (e.g. red and blue) wires.

However, providing distinctive indicia on a conductor's outer cable jacket for each type of wire has its drawbacks. In particular, companies are required to stock many wires, each having their own visually-distinctive cable identifier. In order to accommodate customer orders that require color or indicia-coded cable jackets, companies must stock large numbers of wires having every distinctive color or indicia. Since usage of positive or negative wires is not always equal, the resulting stock imbalances and excess waste can be detrimental to the financial health of a company. The result will lead to inventories overflowing with wires that may never be used, as well as storerooms that quickly run out of available space.

What is needed is a method and apparatus that can reduce the number of wires needed to be available to accommodate customer orders while still providing customers with indicia-coded wires.

### SUMMARY OF THE INVENTION

The present invention advantageously provides a method and apparatus for allowing one wire type to be used for multiple designations by providing a wire with multiple insulation jackets, each of a different characteristic, whereby outer jackets can be removed thus revealing an inner jacket.

In accordance with an embodiment, a wire is provided and includes at least one conductive wire. A first insulation layer having a first characteristic circumferentially surrounds the at least one conductive wire. A second insulation layer having a second characteristic circumferentially surrounds and is separable from the first insulation layer. The first characteristic differs from the second characteristic.

In accordance with another embodiment, a method of making a wire is provided. A first insulating layer is positioned onto at least one conductive wire in which the first insulating layer has a first characteristic. A second insulating layer is positioned onto the first insulating layer. The second layer has a second characteristic different from the first characteristic. The second layer is separable from the first layer.

In accordance with still another embodiment, a wire having a convertible outer layer is provided in which the wire includes at least one conductive wire. A first insulation layer having a first color circumferentially surrounds the at least one conductive wire. A second insulation layer has a second color different from the first color. The second insulation layer has a longitudinal groove and circumferentially surrounds the first layer. The second insulation layer is separable from the first insulation layer.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a perspective view of the present invention showing an outer jacket of a first characteristic and an inner jacket of a second characteristic;

FIG. 2 is a perspective view of an embodiment of the present invention showing a longitudinal groove in the outer jacket to enable the outer jacket to be separated from the inner jacket;

FIG. 3 is a perspective view of another embodiment of the present invention showing a removable tear strip in the outer jacket to enable the outer jacket to be separated from the inner jacket;

FIG. 4 is a perspective view of another embodiment of the present invention showing a plurality of circumferential grooves in the outer jacket to enable portions of the outer jacket to be separated from the inner jacket;

FIG. 5 is a perspective view of another embodiment of the present invention showing a color-coded indicator used to identify the color of the inner jacket; and

FIG. 6 is a cross sectional view of the embodiment shown in FIG. 2.

### DETAILED DESCRIPTION OF THE INVENTION

The present invention provides a wire and method to reduce the number of color-coded or indicia-coded wires in inventory while still providing the purchaser with the safety and convenience associated with coding wires by a distinctive color and/or indicia. A first, inner insulation jacket is positioned around, e.g., wrapped around, extruded onto, etc., one or more conductive wires. The inner insulation jacket includes a first characteristic. A second, outer insulation jacket is then positioned around, e.g., wrapped around, extruded onto, etc. the inner insulation jacket. The outer jacket includes a second characteristic that is different from the first characteristic. The characteristics may be a particular color or texture, or may include a pattern or distinctive markings. The outer jacket also includes a groove or other feature that enables the user to easily remove the outer jacket to reveal the inner jacket and its characteristic. Other means could be used to remove the outer jacket including a removable tear strip. A color-coded indicator strip can be removably affixed to the outer jacket to provide an indicator that corresponds to the characteristic of the inner jacket, which initially, is not visible until the outer jacket is removed.

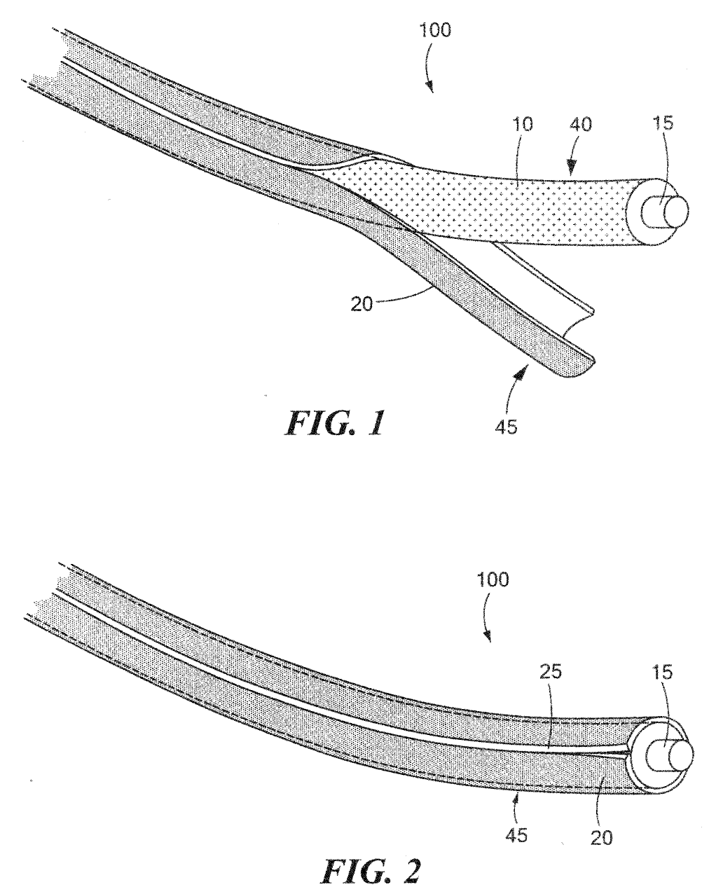

Referring now to the drawing figures in which like reference designators refer to like elements, there is shown in FIG. 1 a diagram of an exemplary wire constructed in accordance with the principles of the present invention and designated generally as “100”. A first, inner insulation jacket layer 10 is extruded onto or otherwise placed circumferentially over one or more wire conductors 15. Inner jacket 10 covers substantially all of the conductors 15. A second, outer insulation jacket layer 20 is extruded onto or otherwise circumferentially placed around inner layer 10. In one embodiment, outer jacket 20 completely covers inner jacket 10 such that, initially, inner jacket 10 cannot be seen. However, in FIG. 1, for illustrative purposes, inner jacket 10 is exposed underneath outer jacket 20, due to a portion of outer jacket 20 being peeled back. Insulation jackets 10 and 20 may be made of rubber, plastic or any other typical insulation material used to cover, insulate and protect electrical wires.

Inner jacket 10 and outer jacket 20 each include a different corresponding characteristic 40, 45 respectively. The characteristic could be one or a combination of any features that can be identified by any one of a user's senses. For example, a characteristic could be a particular color. Outer insulation jackets for electrical conductors are often color-coded to provide the user with a visual indication as to what purpose the wires contained within the jacket are to be used for. For example, in building applications, the color white typically identifies a “neutral” wire, while a black or a red jacket typically identifies “hot” wires. A green jacket may signify a “ground” wires. Further identifying colors are often used to identify high voltage (typically brown, orange and yellow) and low voltage (e.g. red and blue) wires.

As another example, a wire constructed in accordance with the principles of the present invention can use a red outer jacket 20 and a black inner jacket 10 or vice versa. The colors red and black wires are prevalent in low voltage applications for power and ground connections, respectively. For example, such a low voltage application is the automotive audio/video industry for the power and ground connections to audio (and/or video) components.

Another type of characteristic is a visually-discernable design or pattern, as shown in FIG. 1. For example, a series of stripes or a cross-hatch design pattern may adorn the outer jacket 20, and a second pattern is used on the inner jacket 10, where each pattern is associated with a particular wire use. Another example of a characteristic is texture. The jacket may have a particular texture and when touched by the user, immediately identifies the use of the wire, e.g. “hot”, “ground”, “neutral”, “high voltage”, etc. The invention disclosed herein is not limited to a particular characteristic and may use any characteristic or a combination of more than one characteristic, e.g., color, texture, design pattern etc., that is discernable by one or more human senses. Any characteristic that can be associated with a particular wire category, e.g., hot, ground, neutral, etc, can be used.

In an embodiment of the present invention, outer jacket 20 has a particular characteristic 45 that is different from the characteristic 40 of inner jacket 10. Further, outer jacket 20 is easily removable from its initial orientation around inner jacket 10. Thus, by providing an inner jacket 10 and an outer jacket 20 having differing characteristics 40, 45 and an outer jacket 20 that can be removed to reveal inner jacket 10 underneath, the present invention allows the user to essentially use the same conductors for different purposes by simply selecting one of the two insulation jackets.

Thus, in its simplest application, the convertible cable apparatus of the present invention allows the seller of electrical wire to stock only one type of cable, which can be used to identify two different types of wire usage, e.g., positive and negative wire usage. The cable of the present invention allows the user to quickly and easily designate a particular usage for the wire simply by leaving the outer jacket 20 in place, or by removing the outer jacket 20 and discarding it, leaving the inner jacket 10 and its characteristic 40, exposed.

The invention is not limited to only two concentric jackets. The invention allows an unlimited number of jackets to be placed around each other. In this fashion, the supplier of the cable need not stock excessive amounts of wires, each of a particular characteristic. Instead, the seller can sell conductor wire with, for example, multiple jacket color layers, thus allowing the purchaser of the wire to simply remove jacket layers until the proper color, i.e. the color corresponding to the wire's designation, is exposed.

FIG. 2 illustrates one way that the outer jacket 20 may be removed from around the inner jacket 10 in order to reveal the characteristic 40 of the inner jacket 10 to the user. Outer jacket 20 includes a longitudinal groove 25 along its substantial length. Groove 25 can actually be a split in outer jacket 20 or be a seam within outer jacket 20 that allows the user to easily split apart outer jacket 20 in order to expose inner jacket 10. Groove 25 need not run any particular distance along outer jacket 20 but may merely be long enough to allow the user to grasp and lift a portion of outer jacket 20 in order to peel it back and remove it. Once outer jacket 20 is removed, inner jacket 10 now becomes the “outer jacket” over the electrical conductors. Inner jacket 10 may also include a groove 25 to allow the user to remove it to expose additional interior jacket layers. Of course, the user may not need to remove outer jacket 20 at all. For example, if the wires are intended to be ground wires, and the outer jacket 20 is already colored green, indicating “ground”, then the user simply leaves outer jacket 20 in place.

The groove 25 illustrated in FIG. 2 may be replaced by a notch, which allows the user to grasp a small portion of outer jacket 20, peel it back, and remove it, thus exposing inner layer 2. The invention is intended to include all other types of outer jacket 20 removal mechanisms.

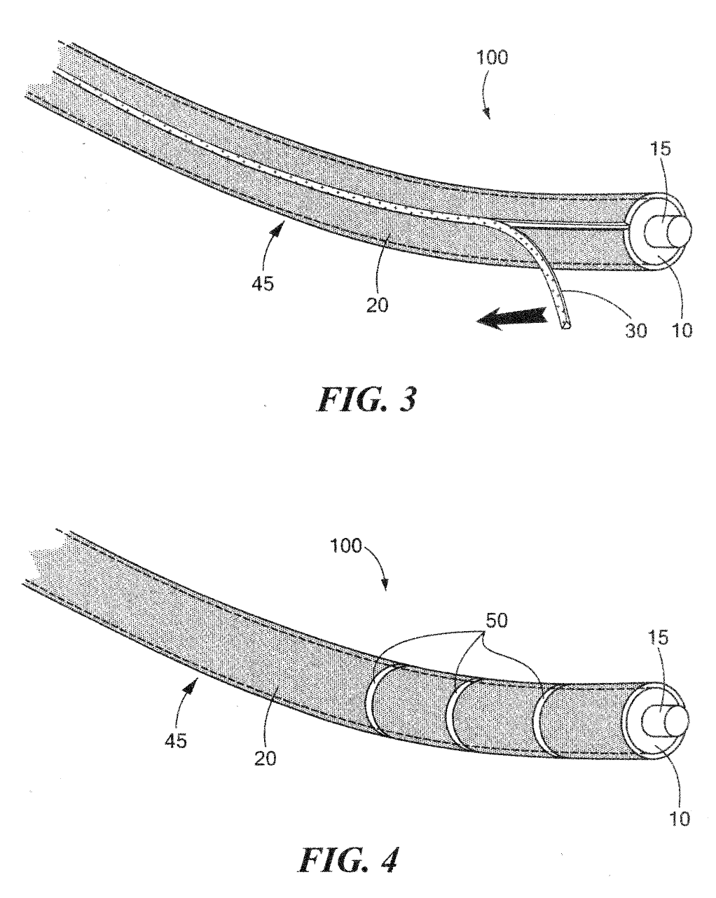

For example, as shown in FIG. 3, a removable tear strip 30 can be affixed to or made part of the outer surface of outer layer 20. Tear strip 30 can be a piece of material which, when pulled, lifts a portion of outer jacket 20 along with it. Thus, after removing tear strip 30, outer jacket 20 may be peeled away via use of a groove or seam now exposed due to the removal of tear strip 30, leaving inner jacket 10 exposed. In one embodiment, outer jacket 20 is thinner than inner jacket 10 in order to facilitate the removal of outer jacket 20.

FIG. 4 shows another embodiment of the present invention. In this embodiment, instead of the longitudinal groove 25 of FIG. 2, outer jacket 20 may include one or more circumferential grooves 55. These grooves 55 transversely encircle outer jacket 20 and may be used to easily remove a portion of outer jacket 20 to reveal the color of inner jacket 10.

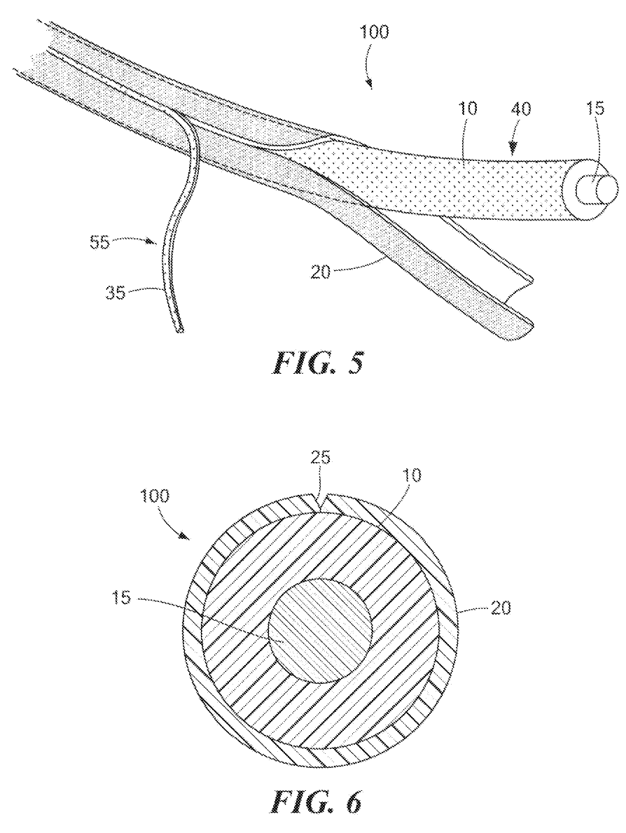

In FIG. 5, an alternate embodiment of the present invention is shown. In this embodiment, outer jacket 20 includes a color-coded removable strip or indicator 35. The color of indicator 35 provides a color code 55 for the wire depending on whether the indicator 35 is left on the outer jacket 20 or removed. Color indicator 35 can be used as an indicator corresponding with the color of one of the concealed inner jackets 10. For example, a user may require that a conductor's outer jacket 20 be green in order to signify a “ground” conductor. The conductor of the present invention may have a two-jacket design, with the inner jacket 10 being green and the outer jacket 20 being red. A color indicator 35 having a green color code 55 signifies to the user that the color of the interior jacket 10 is also green. Thus, if the user wants to indicate that the wires are to be used as “ground” wires, the user, viewing green indicator 35 knows that a green inner jacket 10 is beneath the outer red jacket 20. The user can simply remove the outer jacket 20 by any of the aforementioned outer jacket removal mechanisms, to reveal the green inner jacket 10 in order to use the wires as ground wires.

FIG. 6 shows a cross-sectional view of the wire 100 of the present invention shown in FIG. 2. The concentric design of the multi-layered wire of the present invention can be seen. Conductors 15 are surrounded by a first insulation jacket 10, which is surrounded by a second insulation jacket 20. As discussed, the invention is not limited to only two layers but may be expanded to use additional layers where each layer has a corresponding characteristic different from each other layer's characteristic. It is contemplated that the thickness of the first insulation jacket 10 can be thicker than the thickness of the second insulation jacket 20 to facilitate removal and also to allow management of the overall diameter of wire 100. Groove 25, one of the many jacket-removal mechanisms that can be used with the multi-jacket cable disclosed herein is shown.

The present invention is an apparatus and method that provides users of electrical wires with the ability to utilize the wires for a number of different wire designations by keeping or removing one or more outer insulation layers. Each layer has a distinctive characteristic, such as but not limited to color, texture, or design or a combination of two or more of these features. Instead of stocking wires, each having a particular jacket of a single characteristic, wire providers can now sell wires with dual or multiple-jackets thus significantly reducing their inventory.

On the customer side, a benefit of this arrangement is that users of wire for installations that typically result in unequal use of wire types, e.g., power and ground wires in automotive audio/video applications where power (red) wire use is typically greater than ground (black) wire used, can likewise stock a single supply of multi-purpose wire. Rather than try to guess the ratio of power (red) wire to ground (black) wire used over a period of time and stock wire in that ratio, users need not buy and stock separate wires, each having a jacket with a particular designation. Instead, users can purchase wires incorporating the present invention and simply peel off unwanted jacket layers to reveal the jacket corresponding to the wire's designated use. This advantage is particularly evident in areas where pre-packaged lengths of wire are offered for sale. For example, automotive audio/video system installation kits often include some predetermined length of wire. The present invention advantageously allows a single length of a single wire to be included and allow the user to determine how much wire to “convert” from one jacket type to another. The result in cost and inventory savings is clearly evident.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

1. A wire comprising:
at least one conductive wire;
a first insulation layer having a first characteristic, the first insulation layer circumferentially surrounding the at least one conductive wire; and
a second insulation layer having a second characteristic, the second insulation layer circumferentially surrounding and being separable from the first insulation layer, the first characteristic being visibly discernible from the second characteristic.

2. The wire of claim 1, the first layer having a greater thickness than the second layer.

3. The wire of claim 1, wherein the second layer further includes at least one groove.

4. The wire of claim 1, wherein the second layer further includes a removable longitudinal strip that, when removed, splits apart at least a portion of the second layer.

5. The wire of claim 1, wherein the second layer further includes an indicia-coded removable indicator.

6. The wire of claim 1, wherein the first layer is extruded directly on the one or more conductive wires.

7. The wire of claim 1, wherein the first and the second characteristics are colors.

8. The wire of claim 1, wherein the first and the second characteristics are patterns.

9. The wire of claim 1, wherein the first and the second characteristics are textures.

10. The wire of claim 1, wherein the first characteristic and the second characteristic are each a combination of two more discernable features.

11. The wire of claim 1, further comprising additional insulation layers, each additional insulation layer circumferentially wrapped around another insulation layer.

12. A method of making a wire, the method comprising:
positioning a first insulating layer onto at least one conductive wire, the first insulating layer having a first characteristic; and
positioning a second insulating layer onto the first insulating layer, the second insulating layer having a second characteristic being visibly discernible from the first characteristic, the second insulating layer being separable from the first insulating layer.

13. The method of claim 12, wherein the first insulating layer has a greater thickness than the second insulating layer.

14. The method of claim 12, wherein the second insulating layer further includes at least one groove.

15. The method of claim 12, wherein the second insulating layer further includes a removable strip that, when removed, splits apart at least a portion of the second insulating layer.

16. The method of claim 12, wherein the second insulating layer further includes an indicia-coded removable indicator.

17. The method of claim 12, wherein positioning the first insulating layer on the one or more conductor wires includes extruding the first insulating layer on the one or more conductor wires.

18. The method of claim 12, wherein the first characteristic and the second characteristic are colors.

19. The method of claim 12, wherein the first characteristic and the second characteristic are patterns.

20. A wire having a convertible outer layer, the wire comprising:
at least one conductive wire;
a first insulation layer having a first color, the first insulation layer circumferentially surrounding the at least one conductive wire; and
a second insulation layer having a second color different from the first color, the second layer having a longitudinal groove and circumferentially surrounding and being separable from the first insulation layer.
